(19) United States
(12) Patent Application Publication
(10) Pub. No.: US 2019/0286721 A1
(43) Pub. Date: Sep. 19, 2019

(54) GRAPH BASED RECOMMENDATION ENGINE

(71) Applicant: SAP SE, Walldorf (DE)

(72) Inventors: Amit Sharma, Pathankot (IN); Sherwin Varghese, Kochi (IN); Vijaya Sarathi Durvasula, Bangalore (IN)

(21) Appl. No.: 15/920,363

(22) Filed: Mar. 13, 2018

(51) Int. Cl. G06F 17/30

(52) U.S. Cl. CPC G06F 17/30277; G06F 17/30424

(57) ABSTRACT

A method for generating graph based recommendations may be provided. The method may include querying a database to at least retrieve one or more resource profiles from the database. A graph representative of the one or more resource profiles retrieved from the database may be generated. The graph representative of the one or more resource profiles may include at least one relationship between a first attribute and a second attribute included in the one or more resource profiles. A recommendation for a target user may be generated based on at least a portion of the graph representative of the one or more resource profiles. Related systems and articles of manufacture, including computer program products, are also provided.

### TECHNICAL FIELD

The subject matter described herein relates generally to database processing and more specifically to a graphical recommendation engine.

### BACKGROUND

A database may be configured to store a plurality of electronic data records. These data records are organized, in accordance with a database schema, into various database objects including, for example, database tables, graphs, and/or the like. The database is coupled with a database management system (DBMS) that supports a variety of operations for accessing the data records held in the database. These operations may include, for example, structure query language (SQL) statements.

### SUMMARY

Systems, methods, and articles of manufacture, including computer program products, are provided for a graphical recommendation engine. In one aspect, there is provided a system. The method may include at least one data processor and at least one memory. The at least one memory may store instructions that cause operations when executed by the at least one data processor. The operations may include: querying, by a graphical recommendation engine, a database to at least retrieve one or more resource profiles from the database; generating, by the graphical recommendation engine, a graph representative of the one or more resource profiles retrieved from the database, the graph representative of the one or more resource profiles including at least one relationship between a first attribute and a second attribute included in the one or more resource profiles; and generating, by the graphical recommendation engine, a recommendation for a target user, the recommendation generated based on at least a portion of the graph representative of the one or more resource profiles.

In some variations, one or more features disclosed herein including the following features can optionally be included in any feasible combination. The first attribute and the second attribute may be included in a first resource profile. The recommendation may include a third attribute included in a second resource profile that also includes the first attribute and the second attribute. The graphical recommendation engine may identify the third attribute in response to determining that the first resource profile is same and/or similar to the second resource profile. The graphical recommendation engine may determine that the first resource profile is same and/or similar to the second resource profile by at least applying a collaborative filter to the graph representative of the one or more resource profiles.

In some variations, the recommendation may include the second attribute. The graphical recommendation engine may identify the second attribute by at least traversing the graph representative of the one or more resource profiles. The graph may include a first node associated with the first attribute and a second node associated with the second attribute. The graphical recommendation engine may traverse the graph representative of the one or more resource profiles by at least performing a breadth first search and/or a depth first search. The breadth first search and/or the depth first search may start at the first node associated with the first attribute and follows a directionality of an edge connecting the first node to the second node.

In some variations, the edge connecting the first node and the second node may be associated with a weight. The generation of the graph may include determining the weight based at least on a quantity of users who have transitioned from the first attribute associated with the first node to the second attribute associated with the second node. The recommendation may include identifying, based at least on the weight, the first attribute as being associated with a highest quantity and/or a lowest quantity of users who have transitioned to another attribute.

In some variations, the recommendation may include a shortest path from the first node to the second node. The shortest path may minimize a quantity of nodes and/or time required to transition from the first attribute associated with the first node to the second attribute associated with the second node. The graphical recommendation engine may determine the shortest path by at least applying, to the graph representative of the one or more resource profiles, Dijkstra's algorithm.

In some variations, the graphical recommendation engine may store the graph representative of the one or more resource profiles at the database. The recommendation for the target user may be generated by at least querying the database to retrieve at least the portion of the graph representative of the one or more resource profiles.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to web application user interfaces, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a system diagram illustrating a recommendation system, in accordance with some example embodiments;

FIG. 2 depicts a block diagram illustrating a graphical recommendation engine, in accordance with some example embodiments;

FIG. 3A depicts a graph representative of an resource profile, in accordance with some example embodiments;

FIG. 3B depicts a graph representative of an resource profile, in accordance with some example embodiments;

FIG. 3C depicts a graph representative of a plurality of resource profiles, in accordance with some example embodiments;

FIG. 4 depicts a flowchart illustrating a process for graph based recommendations, in accordance with some example embodiments; and

FIG. 5 depicts a block diagram illustrating a computing system, in accordance with some example embodiments.

When practical, similar reference numbers denote similar structures, features, or elements.

### DETAILED DESCRIPTION

In some example embodiments, a graphical recommendation engine may be configured to generate recommendations for a target user. In order to generate recommendations for the target user, the graphical recommendation engine may generate reference data that includes at least one graph representative of one or more resource profiles of an organization. The graphical recommendation engine may further store the reference data in a database. It should be appreciated that the organization may be associated with a variety of different resources including, for example, employees, job designations, skills, and/or the like. As such, the reference data may be generated based on resource profiles that include, for example, employee profiles, job profiles, and/or the like. Generating recommendations for the target user may include querying the database to retrieve at least a portion of the reference data. Recommendations of the target user may be generated based at least on the reference data retrieved from the database.

To generate the reference data, the graphical recommendation engine may query the database to retrieve, from the database, at least a portion of the resource profiles stored at the database. Alternatively and/or additionally, the graphical recommendation engine may generate recommendations for a target user by at least querying the database to retrieve at least a portion of the reference data stored therein. It should be appreciated that the recommendation engine may query the database using one or more Structured Query Language (SQL) statements such as, for example, a SQL SELECT, and/or the like.

In some example embodiments, the recommendation engine may also update the reference data in response to changes to the resource profiles stored at the database including, for example, the addition, deletion, and/or modification of an organization profile. For instance, the recommendation engine may update the reference data when the recommendation engine detects a SQL statement that indicates a change to one or more resource profiles at the database including, for example, a SQL INSERT, a SQL DELETE, a SQL UPDATE, and/or the like.

Each resource profile may include a plurality of attributes. For instance, an employee profile may include one or more attributes associated with a user including, for example, past and current designations, skills, and/or the like. Meanwhile, a job profile may include one or more attributes associated with a job designation including, for example, the skills required to qualify for the designation. In some example embodiments, the reference data may include one or more graphs representative of these resource profiles. The graphs representative of one or more resource profiles may be directed graphs that includes nodes connected by directed edges. The nodes and the directed edges connecting the nodes may depict relationships existing between the attributes included in the one or more resource profiles. For example, the graph representative of an employee profile may depict the employment history of a user including, for example, relationships between different designations as the user transitions between jobs. Meanwhile, the graph representative of a job profile may depict the qualifications associated with a corresponding designation including, for example, relationships between the designation and the skills required to qualify for the designation. Alternatively and/or additionally, the graph representative of a plurality of employee profiles and/or job profiles may depict the staffing structure of an organization including, for example, the employees currently associated with each designation within the organization, the transition of employees between different designations, the retention rate and/or attrition rate associated with different designations within the organization, and/or the like. As noted, the recommendation engine may generate recommendations based on at least a portion of the reference data. According to some example embodiments, these recommendations may be generated by least applying, to the reference data, one or more data analytic techniques including, for example, graph traversal, collaborative filtering, and/or the like.

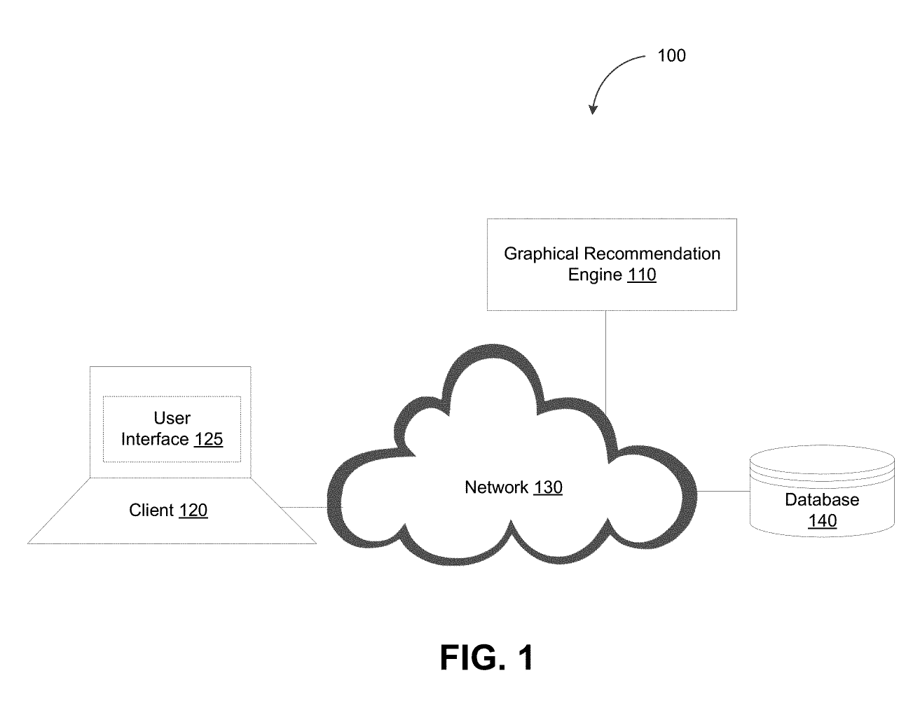

FIG. 1 depicts a system diagram illustrating a recommendation system 100, in accordance with some example embodiments. Referring to FIG. 1, the recommendation system 100 may include a graphical recommendation engine 110 that is communicatively coupled with a client 120 and a database 140. The client 120 may be any type of processor and memory based device including, for example, a cellular phone, smart phone, a tablet, a laptop computer, a desktop, a workstation, and/or the like. The network 130 may be any wired and/or wireless network including, for example, a public land mobile network (PLMN), a local area network (LAN), a wide area network (WAN), a virtual local area network (VLAN), the Internet, and/or the like. The database 140 may be any type of database including, for example, a graph database, an in-memory database, a relational database, a non-SQL (NoSQL) database, and/or the like. Although not shown, it should be appreciated that the database 140 may be coupled with a database management system (DMBS) configured to perform operations (e.g., SQL statements and/or the like) for accessing the data held in the database 140.

The database 140 may store a plurality of resource profiles associated with an organization including, for example, employee profiles, job profiles, and/or the like. In some example embodiments, the graphical recommendation engine 110 may be configured to generate reference data based on the resource profiles stored at the database 140. As such, the graphical recommendation engine 110 may query the database 140 to retrieve at least some of the resource profiles stored in the database 140. For example, the graphical recommendation engine 110 may use SQL statements (e.g., SQL SELECT and/or the like) to retrieve one or more resource profiles from the database 140.

As noted above, each resource profile may include one or more attributes. For instance, an employee profile may include one or more attributes associated with a user including, for example, past and current designations, skills, and/or the like. Alternatively and/or additionally, a job profile may include one or more attributes associated with a designation including, for example, the skills required for the designation. As used herein, a designation may refer to any identifier associated with a job including, for example, a title, a position, a seniority, and/or the like. In some example embodiments, the graphical recommendation engine 110 may generate, based on the resource profiles retrieved from the database 140, reference data that includes one or more graphs representative of at least a portion of the resource profiles including, for example, employee profiles, job profiles, and/or the like. Furthermore, the graphical recommendation engine 110 may store at least a portion of the reference data at the database 140 such that the graphical recommendation engine 110 may query the database 140 in order to generate recommendations based on the reference data.

For example, the graph representative of an individual employee profile may depict the employment history of a user including, for example, a progression from one or more past designations to a current designation held by the user. Meanwhile, the graph representative of an individual job profile may depict the qualifications associated with the corresponding designation including, for examples, the skills that are required for holding the designation. Alternatively and/or additionally, the graph representative of a plurality of employee profiles and/or job profiles may depict the staffing structure of an organization including, for example, the employees currently associated with each designation within the organization, the transition of employees between different designations, the retention rate and/or attrition rate associated with different designations within the organization, and/or the like.

In some example embodiments, the graphical recommendation engine 110 may update the reference data in response to changes to the resource profiles stored at the database 140 such that the reference data is synchronized with the resource profiles stored at the database 140. For example, the graphical recommendation engine 110 may update the reference data in real time by at least detecting operations (e.g., SQL statements and/or the like) that add, delete, and/or modify one or more resource profiles at the database 140. The graphical recommendation engine 110 may update the reference data based on the changes to the resource profiles at the database 140. For instance, the graphical recommendation engine 110 may update graphs representative of the resource profiles when one or more resource profiles at the database 140 are added, removed, and/or modified. Alternately and/or additionally, the graphical recommendation engine 110 may update the reference data periodically and/or in accordance with a predetermined schedule. The graphical recommendation engine 110 may, for example, update the reference data on a weekly basis, monthly basis, a quarterly basis, and/or the like. Such updates may include updating the graphs representative of the resource profiles in accordance with the addition, removal, and/or modification of resource profiles at the database 140.

According to some example embodiments, the graphical recommendation engine 110 may generate, based on the reference data, one or more recommendations. For example, the graphical recommendation engine 110 may receive, from the client 130, a request to generate recommendations for a target user. These recommendations may include designations that the target user should transition, based on the past and current designations held by the target user. Alternatively and/or additionally, these recommendations may include recommendations for achieving a desired designation including, for example, an optimal career path from a current designation to the desired designation that minimizes the quantity of transitions and/or the transition time, one or more required skills associated with the desired designation, and/or the like. These recommendations may further include recommendations for staffing the organization including, for example, identifying designations associated with high attrition rates and/or retention rates, identifying employees with suitable skills for a certain designation, and/or identifying gaps in the current skills of the employees, and/or the like. As noted, the graphical recommendation engine 110 may generate the recommendations by at least applying, to the reference data, one or more data analytic techniques including, for example, graph traversal, collaborative filtering, and/or the like.

Referring again to FIG. 1, the client 120 may interact with the graphical recommendation engine 110 via a user interface 125, which may be a graphic user interface (GUI) and/or any other type of user interface. For example, the user interface 125 may be configured to receive inputs at the client 120 including, for example, the request for the graphical recommendation engine 110 to generate one or more recommendations for the target user. Alternately and/or additionally, the user interface 125 may be configured to display outputs at the client 120 including, for example, the recommendations generated by the graphical recommendation engine 110 for the target user.

It should be appreciated that the graphical recommendation engine 110 may be deployed locally and/or remotely to provide graph based recommendations, for example, to the client 120. For example, the graphical recommendation engine 110 may be provided as computer software and/or circuitry (e.g., application specific integrated circuits (ASICs), field programmable gate arrays (FPGAs), and/or the like) at the client 120. Alternatively and/or additionally, at least some of the functionalities of the graphical recommendation engine 110 may be available remotely via the network 140 as, for example, a cloud based service, a web application, a software as a service (SaaS), and/or the like. Accordingly, the client 120 may be able to invoke at least some of the functionalities of the graphical recommendation engine 110 via an application programming interface (API) including, for example, simple object access protocol (SOAP), representational state transfer (RESTful), and/or the like.

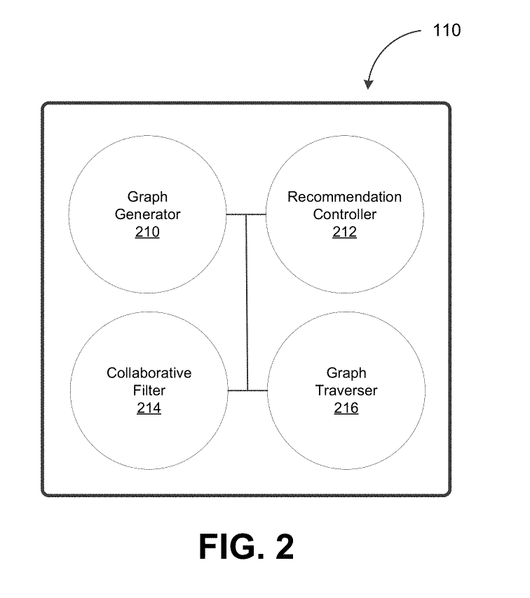

FIG. 2 depicts a block diagram illustrating the graphical recommendation engine 110, in accordance with some example embodiments. Referring to FIGS. 1-2, the graphical recommendation engine 110 may include a graph generator 210, a recommendation controller 212, a collaborative filter 214, and a graph traverser 216. It should be appreciated that the graphical recommendation engine 110 may include additional and/or different components than shown.

In some example embodiments, the graph generator 210 may be configured to generate reference data that includes one or more graphs representative of the resource profiles stored in the database 140. The resource profiles stored in the database 140 may include, for example, employee profiles, job profiles, and/or the like. As noted, the graph representative of an individual employee profile may depict the employment history of a user including, for example, a progression from one or more past designations to a current designation held by the user. Meanwhile, the graph representative of an individual job profile may depict the requirements associated with the corresponding designation including, for examples, the skills that are required for holding the designation. Alternatively and/or additionally, the graph representative of a plurality of employee profiles and/or job profiles may depict the staffing structure of an organization including, for example, the employees currently associated with each designation within the organization, the transition of employees between different designations, the retention rate and/or attrition rate associated with different designations within the organization, and/or the like.

Consider an organization O that is associated with a plurality of resources including, for example, a set of employees E, a set of designations D, a set of skills S, and/or the like. The set of employees E may include an i quantity of employees and may thus be denoted as E={e¹, e², e³, e⁴, . . . , eⁱ}. Meanwhile, the set of designations D may include a j quantity of designations and may thus be denoted as D={d¹, d², d³, d⁴, . . . , d^{j}} As noted, a designation may refer to any identifier associated with a job including, for example, a title, a position, a seniority, and/or the like. The set of skills S may include a k quantity of unique skills exhibited by the set of employees E of the organization O. This set of skills S may be denoted as S={s¹, s², s³, s⁴, . . . , s^{k}}.

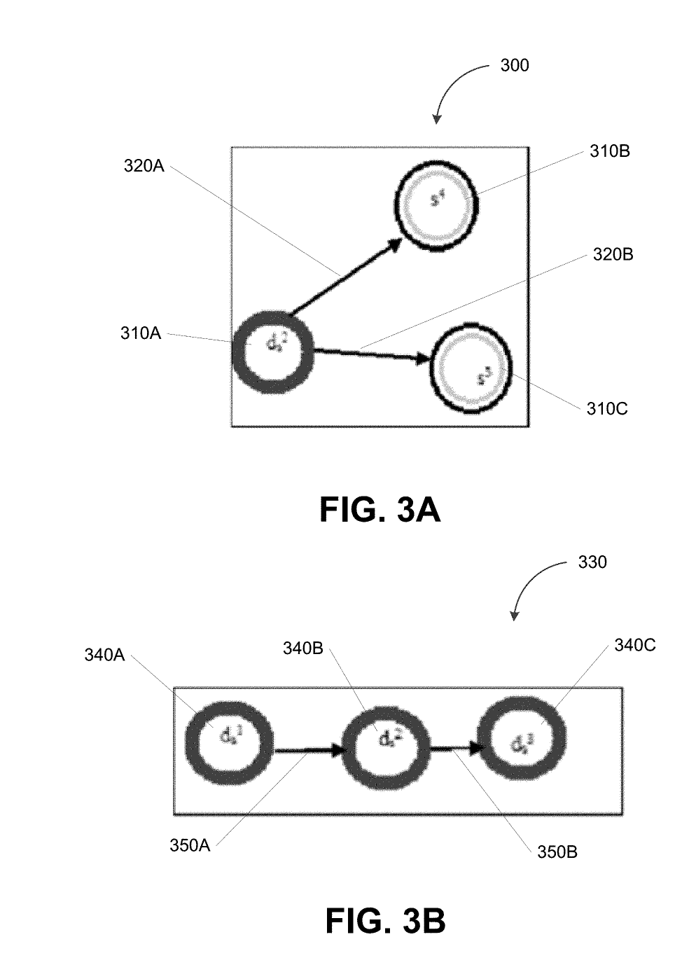

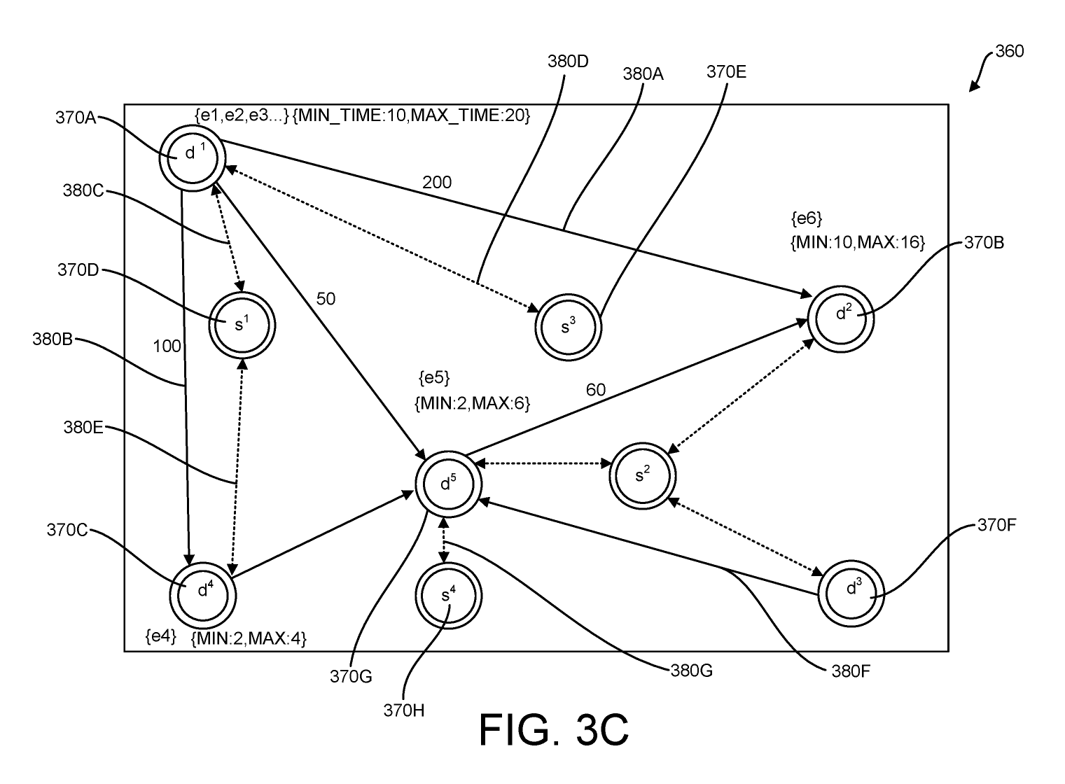

In some example embodiments, the graph generator 210 may generate a graph representative of an individual resource profile such as, for example, the job profile for a job having a designation d². To further illustrate, FIG. 3A depicts a graph 300 representative of a job profile, in accordance with some example embodiments. Referring to FIG. 3A, the graph 300 may depict a correlation between a designation d², a skill s³, and a skill s⁴. For example, the graph 300 may include a plurality of nodes including, for example, a first node 310A, a second node 320B, and a third node 320C. The first node 310A may correspond to the designation d², the second node 320B may correspond to the skill s³, and the third node 320C may correspond to the skill s⁴. Furthermore, the graph 300 may include a plurality of directed edges joining the first node 310A, the second node 310B, and/or the third node 310C. For instance, a first edge 320A from the first node 310A to the second node 310B may indicate that the qualifications for the designation d² include the skill s⁴. Alternatively and/or additionally, a second edge from the first node 310A to the third node 310C may indicate that the qualifications for the designation d² further include the skill s³. According to the graph 300, for an employee e^{x} to hold the designation d², the employee e^{x} may be required to possess both the skill s³ and the skill s⁴. This correlation between the designation d², the skill s³, and the skill s⁴ may be denoted as dₛ²:{s³, s⁴}.

Alternatively and/or additionally, the graph generator 210 may also generate a graph representative of the employee profile of an employee e^{x}. To further illustrate, FIG. 3B depicts a graph 330 representative of an employee profile, in accordance with some example embodiments. Referring to FIG. 3B, the graph 330 may depict an employment history of the employee e^{x}, which may include a designation d¹, a designation d², and a designation d³. To depict the employment history of the employee e^{x}, the graph 330 may include sequence of nodes, which may be interconnected by one or more directed edges. For instance, as shown in FIG. 3B, the graph 330 may include a plurality of nodes including, for example, a first node 340A, a second node 340B, and a third node 340C. The first node 340A may correspond to the designation d¹, the second node 340B may correspond to the designation d², and the third node 340C may correspond to the designation d³. Furthermore, the graph 330 may include a plurality of directed edges including, for example, a first edge 350A and a second edge 350B.

Referring again to FIG. 3B, the first edge 350A from the first node 340A to the second node 340B may indicate that the employee e^{x} transitioned from the designation d¹ to the designation d², for example, by changing from a job having the designation d¹ to a different job having the designation d². Meanwhile, the second edge 350B from the second node 340B to the third node 340C may indicate that after transitioning to the designation d², the employee e^{x} transitioned again from the designation d² to the designation d³. This transition may correspond to a change from the job having the designation d² to another job having the designation d³. According to the graph 330, the employment history of the employee e^{x} may include a transition from the designation d¹ to the designation d² and another transition from the designation d² to the designation d³. The employment history for the employee e^{x} may be denoted as Eₕ^{x}:{d¹→d²→d³} or Eₕ^{x}:{d¹, d², d³}. As noted, each designation may be associated with one or more skills, which may be required in order to qualify for the designation. Thus, it should be appreciated that the graph 330 may further indicate that the employee e^{x} may possess the skills required to qualify for each of the designations included in the employment history of the employee e^{x}. For example, based on the employee e^{x} having held the designation d², the employee e^{x} may possess the skill s³ and the s⁴ required for holding the designation d².

In some example embodiments, the graph generator 210 may generate a graph representative of a plurality of resource profiles including, for example, job profiles, employee profiles, and/or the like. To further illustrate, FIG. 3C depicts a graph 360 representative of a plurality of resource profiles, in accordance with some example embodiments. Referring to FIG. 3C, the graph generator 210 may generate the graph 360 by merging a plurality of graphs representative of job profiles (e.g., the graph 300) and graphs representative of employee profiles (e.g., the graph 330). The graph representative of an employee profile may depict the employment history of an employee (e.g., the employee e^{x}) which may include, for example, transitions between various designations within the organization (e.g., Eₕ^{x}:{d¹→d²→d³} or Eₕ^{x}:{d¹, d², d³}). Meanwhile, the graph representative of a job profile may depict the skills required to qualify for the corresponding designation. Accordingly, the resulting graph 360 may depict the transitions between designations undertaken by various different employees as well as the skills required to qualify for these designations.

As noted, the organization O may be associated with the set of employees E={e¹, e², e³, e⁴, . . . , eⁱ}, which may include an i quantity of employees. Accordingly, the graph 360 may be generated by merging at least some of graphs representative of the corresponding i quantity of employee profiles from the set of employee profiles Eₕ={Eₕ¹, Eₕ², Eₕ³, Eₕ⁴, . . . , Eₕⁱ}. In doing so, the graph 360 may depict the transitions between a plurality of designations taken by at least some of the i quantity of employees included in the set of employees E={e¹, e², e³, e⁴, . . . , eⁱ}. Furthermore, the graph 360 may also depict the employees currently associated with each of the plurality of designations as well as the skills required to qualify for these designations. Alternatively and/or additionally, the graph 360 may depict the retention rate and/or attrition rate associated with each of the plurality of designations.

In some example embodiments, the graph 360 may depict the transitions between designations taken by at least some of the i quantity of employees included in the set of employees E={e¹, e², e³, e⁴, . . . , eⁱ} Referring to FIG. 3C, the graph 360 may be a directed graph having a plurality of nodes connected by one or more directed edges. The directionality of the edges connecting a pair of nodes may indicate a transition between the two nodes. As noted, the organization O may be associated with the set of designations D, which may include a j quantity of designations (e.g., D={d¹, d², d³, d⁴, . . . , d^{j}}. Accordingly, the graph 360 may include a j quantity of nodes associated with the j quantity of designations at the organization O.

For example, as shown in FIG. 3C, the graph 360 may include a first node 370A, which may be connected to a second node 370B by a first edge 380A. The first edge 380A from the first node 370A to the second node 370B may indicate a transition from a designation d¹ associated with the first node 370A and a designation d² associated with the second node 370B. Furthermore, the graph generator 210 may assign, to the first edge 380A, a weight (e.g., 200 or a different value), the value of which corresponding to a quantity of employees who have made the transition from the designation d¹ to the designation d². Alternatively and/or additionally, the first node 370A may also be connected to a third node 370C via a second edge 380B. The second edge 380B from the first node 370A to the third node 370C may indicate a transition from the designation d¹ associated with the first node 370A to a designation d⁴ associated with the third node 370C. The weight (e.g., 100 or a different value) associated with the second edge 380B may correspond to a quantity of employees who have made the transition from the designation d¹ to the designation d⁴. In some instances, no employee may have transitioned between two designations but an edge may nevertheless connect the two corresponding nodes. Here, the graph generator 210 may assign a weight (e.g., −1 or a different value) indicating that no employees have made a transition between these two designations. According to some example embodiments, the graph generator 210 may update the weight assigned to an edge to reflect changes to the quantity of employees who have made a transition between the designations associated with the nodes connected by the edge.

In some example embodiments, the graph 360 may also depict the qualifications associated with a plurality of designations including, for example, the skills required for holding each individual designation. Referring again to FIG. 3C, the first node 370A may be connected to a fourth node 370D (e.g., via a third edge 380C) and a fifth node 370E (e.g., via a fourth edge 380D). The connection between the first node 370A and the fourth node 370D may indicate that the designation d¹ requires a skill s³ associated with the fourth node 370D. Meanwhile, the connection between the first node 370A and the fifth node 370E may indicate that the designation d¹ further requires a skill s³ associated with the fifth node 370E. It should be appreciated that some designations may require the same skills. For instance, as shown in FIG. 3C, in addition to be connected to the first node 370A, the fourth node 370D associated with the skill s¹ may also be connected to the third node 370C via a fifth edge 380E. Accordingly, both the designation d¹ associated with the first node 370A and the designation d⁴ associated with the third node 370C may require the skill s¹ associated with the fourth node 370D.

In some example embodiments, the graph generator 210 may generate the graph 360 to further depict the current employees associated with each of the j quantity of designations included in the set of designations D={d¹, d², d³, d⁴, . . . , d^{j}}. As shown in FIG. 3C, each node associated with a designation may further be associated with a list of employees, which may include at least some of the i quantity of employees included in the set of employees E={e¹, e², e³, e⁴, . . . , eⁱ}. For instance, the first node 370A may be associated with a list of employees {e¹, e², e³} currently holding the designation d¹ while the second node 370B may be associated with a different list of employees {e⁶} currently holding the designation d². As employees transition between different designations, the graph generator 210 may update the list of employees associated with a node to reflect changes to employees currently holding the corresponding designation.

In some example embodiments, the graph generator 210 may generate the graph 360 to depict the retention rate and/or the attrition rate with each of the j quantity of designations included in the set of designations D={d¹, d², d³, d⁴, . . . , e^{j}}. As shown in FIG. 3C, each node associated with a designation may be associated with a minimum time (e.g., MIN TIME) and a maximum time (e.g., MAX_TIME). The minimum time associated with a node may correspond to the shortest timespan during which an employee held the designation associated with that particular node whereas the maximum time associated with the node may correspond to the longest timespan during which an employee held the designation associated with the node. For example, the first node 370A may be associated with a minimum time (e.g., MIN TIME), which may correspond to the smallest quantity of time an employee held the designation d¹ before moving onto another designation such as, for example, the designation d², the designation d⁴, and/or the designation d⁵. Alternatively and/or additionally, the first node 370B may also be associated with a maximum time (e.g., MAX_TIME), which may correspond to the largest quantity of time an employee held the designation d¹ before moving onto another designation such as, for example, the designation d², the designation d⁴, and/or the designation d⁵.

The recommendation controller 212 may be configured to generate, based on reference data generated by the graph generator 210, one or more recommendations for a target user at the client 130. As noted, the reference data generated by the graph generator 210 may include graphs representative of one or more resource profiles including, for example, employee profiles, job profiles, and/or the like. In some example embodiments, these recommendations may include recommendations for building a career path that includes, for example, one or more subsequent designations that the target user should transition to. These recommendations may be generated by applying one or more data analytics techniques to the reference data including, for example, collaborative filtering, graph traversal, and/or the like.

In some example embodiments, to generate recommendations for a target user at the client 130, the collaborative filter 214 may identify, for example, through collaborative filtering, other users who have a same and/or similar employment history as the target user. As used herein, two users may be deemed to have a same and/or similar employment history if the two users have transitioned through a threshold quantity of the same designations. The recommendations for the target user may include at least some of the designations held by the other users that the collaborative filter 214 has identified as having a same and/or similar employment history as the target user. Furthermore, the recommendations for the target user may include the skills required to qualify for the designations held by the other users that the collaborative filter 214 has identified as having a same and/or similar employment history as the target user. For example, the graph traverser 216 may identify the skills required to qualify for a particular designation by at least traversing a graph (e.g., the graph 360) starting from a node associated with that particular designation and following a directionality of the edges originating from that node to one or more other nodes associated with skills. It should be appreciated that the graph traverser 216 may traverse a graph in any manner including, for example, by performing a breadth first search (BFS), a depth first search (DFS), and/or the like.

To further illustrate, consider the employee e^{x} whose employment history Eₕ^{x} includes transitions from the designation d¹ to the designation d² and the designation d³ (e.g., Eₕ^{x}:{d¹→d²→d³} or Eₕ^{x}:{d¹, d², d³}). The collaborative filter 214 may identify other employees having the same and/or similar employment history including, for example, an employee e^{y}. In some example embodiments, the recommendation controller 212 may generate recommendations for the employee e^{x} based on the employment history Eₕ^{y} of the employee e^{y}. For instance, the collaborative filter 214 may identify the employee e^{y} as having a same and/or similar employment history as the employee e^{x} because the employment history Eₕ^{y} of the employee e^{y} may also include transitions from the designation d¹ to the designation d² and the designation d³. In addition, the employment history of the employee e^{y} may also include transitions from the designation d³ to a designation d⁴ (e.g., Eₕ^{x}:{d¹→d²→d³→d⁴} or Eₕ^{x}:{d¹, d², d³, d⁴}). As such, the recommendation controller 212 may generate recommendations indicating that the employee e^{x} should transition to the designation d⁴. Moreover, the graph traverser 216 may traverse the graph 360 to determine that the designation d⁴ requires the skill s′. Accordingly, the recommendation controller 212 may generate recommendations indicating that the employee e^{x} should the skill s¹ in order to qualify for the designation d⁴.

Alternatively and/or additionally, to generate recommendations for the target user at the client 130, the graph traverser 216 may traverse a graph (e.g., the graph 360) starting from a node associated with a current designation held by the target user. Traversing the graph from the node associated with the current designation of the target user may enable the graph traverser 216 to identify possible transitions to nodes associated with other designations. For instance, consider the employee e^{x} whose employment history Eₕ^{x} indicates that the employee e^{x} currently holds the designation d³. Here, the graph traverser 216 may identify possible transitions for the employee e^{x} by at least traversing the graph 360, for example, starting from a sixth node 370F associated with the designation d³. As noted, the graph traverser 216 may traverse a graph in any manner including, for example, by performing a breadth first search (BFS), a depth first search (DFS), and/or the like. In doing so, the graph traverser 216 may determine that the employee e^{x} may transition from the designation d³ to a designation d⁵, which may be associated with a seventh node 370G that is connected to the sixth node 370F associated with the designation d³ via a sixth edge 380F. Accordingly, the recommendation controller 212 may generate a recommendation indicating that the employee e^{x} should transition to the designation d⁵. Moreover, as noted, the recommendation may further indicate that the employee e^{x} should acquire the skills required to qualify for the designation d⁵ including, for example, a skill s² associated with an eight node 370H connected to the seventh node 370G associated with the designation d⁵ via a seventh edge 380G.

In some example embodiments, the recommendation controller 210 may generate recommendations based on a desired designation as specified by the target user at the client 130. For example, the target user may indicate a desire to transition to a certain designation. Here, the graph traverser 216 may traverse a graph (e.g., the graph 360) to identify one or more possible paths from a current designation of the target user to the desired designation specified by the target user. Furthermore, the graph traverser 216 may identify a shortest path between the current designation of the target user and the desired designation specified by the user. It should be appreciated that the shortest path between the current designation of the target user and the desired designation specified by the user can be determined in any manner including, for example, Dijkstra's algorithm and/or the like. The shortest path between the current designation of the target user and the desired designation specified by the user may minimize a quantity of intervening designations between the current designation of the target user and the desired designation specified by the user. Alternatively and/or additionally, the shortest path between the current designation of the target user and the desired designation specified by the user may minimize a quantity of time required to transition from the current designation of the target user and the desired designation specified by the user. The quantity of transition time may be determined based on a minimum time (e.g., MIN TIME) and/or a maximum time (e.g., MAX_TIME) associated with each node that corresponds to a designation.

To further illustrate, consider again the employee e^{x} who currently holds the designation d³ but wishes to transition to a designation d^{z}. The recommendation controller 212 may be configured to generate a recommendation that includes one or more possible paths from the designation d³ to the designation d^{z}. In some example embodiments, the recommendation may include a shortest path from the designation d³ to the designation d^{z}. The shortest path from the designation d³ to the designation d^{z} may minimize a quantity of intervening designations and/or a quantity of transition time between the designation d³ to the designation d^{z}.

As noted, the recommendations controller 212 may be configured to generate recommendations for the target user at the client 130 based on the reference data generated by the graph generator 210. In some example embodiments, these recommendations may correspond to one or more aspects of the staffing structure associated with the organization O including, for example, the employees currently associated with each designation within the organization O, the transition of employees between different designations, the retention rate and/or attrition rate associated with different designations within the organization O, and/or the like.

For example, the recommendation controller 212 may identify, based on the graph 360, designations, for example, from the set of designations D={d¹, d², d³, d⁴, . . . , d^{j}} having high attrition rates and/or low retention rates. The attrition rate and/or retention rate associated with a designation may be determined based on the minimum time (e.g., MIN TIME) and/or the maximum time (e.g., MAX_TIME) associated with the corresponding node, which may indicate a length of time employees spend at the designation. A designation may be associated with a high attrition rate if the length of time employees spend at the designation is below a threshold value and/or less than the length of time employees spend at other designations. Alternatively and/or additionally, the attrition rate and/or the retention rate associated with a designation may be determined based on the weights assigned to the edges leading away from the corresponding node. As noted, the weight assigned to an edge connecting one designation to another designation may correspond to quantity of employees who transitioned from the one designation to the other designation. Accordingly, a designation may be associated with a high attrition rate if the edges leading away from a corresponding node are assigned weights that exceed a threshold value and/or are higher than the weights assigned to edges leading away from nodes associated with other designations.

Alternatively and/or additionally, the recommendation controller 212 may identify, based on the graph 360, employees from the set of employees E={e¹, e², e³, e⁴, . . . , eⁱ} at the organization O who have one or more skills required for an open position with the designation d^{z}. As noted, each node associated with a designation may be connected to one or more nodes associated with the skills required to qualify for the designation. Moreover, each node may be associated with a list of employees currently holding the corresponding designation. Thus, in some example embodiments, the recommendation controller 212 may identify the employees currently holding a designation based on the employee list associated with the corresponding node. Furthermore, the recommendation controller 212 may identify these employees as having the skills associated with the nodes that are connected to the node associated with the designation.

For instance, the job profile for the designation d^{z} may indicate that the designation d^{z} requires the skill s¹ and the skill s⁴ (e.g., dₛ^{z}:{s¹, s⁴}). Based on the graph 360, the recommendation controller 212 may identify other designations that require the skills s¹ and s⁴. For example, both the designation d¹ and the designation d⁴ require the skill s¹. As such, the recommendation controller 212 may identify the employees currently holding the designations d¹ and d⁴ (e.g., the employees e¹, e², e³, and e⁴) as having the skill s¹ required for the designation d^{z}. Meanwhile, the designation d⁵ may require the skill s⁴. Accordingly, the recommendation controller 212 may identify the employees currently holding the designation d⁵ (e.g., e⁵) as having the skills s⁴ required for the designation d^{z}. According to some example embodiments, the recommendation controller 212 may recommend the employees e¹, e², e³, e⁴, and e⁵ as potential candidates for open position with the designation d^{z}.

In some example embodiments, the recommendation controller 212 may also identify skills that are absent from the organization O. For example, referring again to FIG. 3C, the graph 360 may depict the full sets of skills S={s¹, s², s³, s⁴, . . . , s^{k}} currently available at the organization O. That is, the nodes corresponding skills may indicate the skills possessed by the set of employees E at the organization O. Based on this set of skills S, the recommendation engine 210 may identify skill gaps, which may correspond to skills that are absent from the set of skills S.

In some example embodiments, the recommendation controller 212 may generate, based on the reference data generated by the graph generator 210, recommendations for increasing diversity with the organization O, training certain employees to avoid and/or fill one or more skill gaps at the organization O, and/or allocating performance-based rewards. Alternatively and/or additionally, the recommendation controller 212 may generate, based on the reference data generated by the graph generator 210, recommendations for achieving certain designations and/or skills, and/or career paths that minimizes the quantity of transitions and/or transition time for achieving a desired designation.

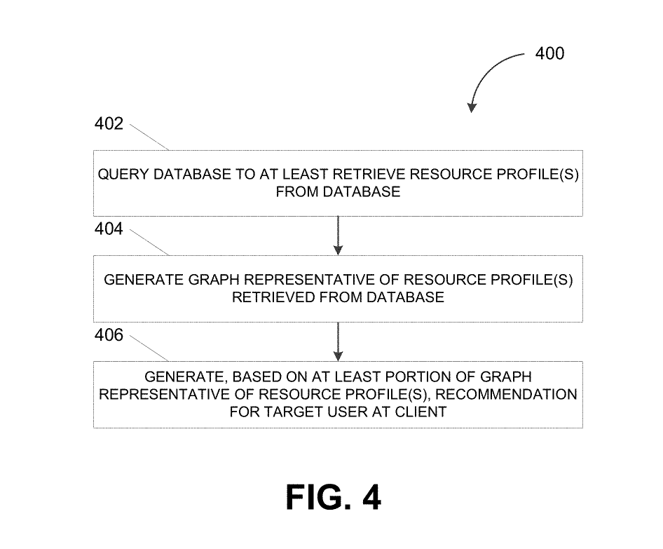

FIG. 4 depicts a flowchart illustrating a process 400 for graph based recommendations, in accordance with some example embodiments. Referring to FIGS. 1-2, 3A-C, and 4, the process 400 may be performed by the graphical recommendation engine 110.

At 402, the graphical recommendation engine 110 may query the database 140 to at least retrieve one or more resource profiles. In some example embodiments, the graphical recommendation engine 110 may query the database 140 to retrieve one or more resource profiles including, for example, employee profiles, job profiles, and/or the like. The graphical recommendation engine 110 may retrieve the user profiles using a SQL statement such as, for example, a SQL SELECT and/or the like. As noted, an employee profile may include one or more attributes associated with a user including, for example, past and current designations, skills, and/or the like. Meanwhile, a job profile may include one or more attributes associated with a job designation including, for example, the skills required to qualify for the designation.

At 404, the graphical recommendation engine 110 may generate a graph representative of the one or more resource profiles retrieved from the database 140. In some example embodiments, the graphical recommendation engine 110 may generate reference data that includes at least one graph that is representative of one or more employee profiles, job profiles, and/or the like. As noted, the graph representative of one or more resource profiles may depict at least one relationship between the attributes included in the one or more resource profiles. For example, the graph representative of an employee profile may depict the employment history of a user including, for example, past and current designations held by the user whereas the graph representative of a job profile may depict the qualifications associated with a corresponding designation including, for example, the skills required to qualify for the designation. Alternatively and/or additionally, the graph representative of a plurality of employee profiles and/or job profiles may depict the staffing structure of an organization including, for example, the employees currently associated with each designation within the organization, the transition of employees between different designations, the retention rate and/or attrition rate associated with different designations within the organization, and/or the like.

At 406, the graphical recommendation engine 110 may generate, based on at least a portion of the graph representative of the one or more resource profiles, a recommendation for a target user at the client 130. In some example embodiments, the graphical recommendation engine 110 may generate recommendations that include designations that the target user should transition, based on past and current designations held by the target user. Alternatively and/or additionally, the recommendation engine 210 may generate recommendations that include recommendations for achieving a desired designation specified by the target user including, for example, an optimal career path from a current designation to the desired designation that minimizes the quantity of transitions and/or the transition time, one or more required skills associated with the desired designation, and/or the like. The recommendation engine 210 may also generate recommendations for staffing the organization including, for example, identifying designations associated with high attrition rates and/or retention rates, identifying employees with suitable skills for a certain designation, and/or identifying gaps in the current skills of the employees, and/or the like. The graphical recommendation engine 110 may generate the recommendations by at least applying, to the reference data, one or more data analytic techniques including, for example, graph traversal, collaborative filtering, and/or the like.

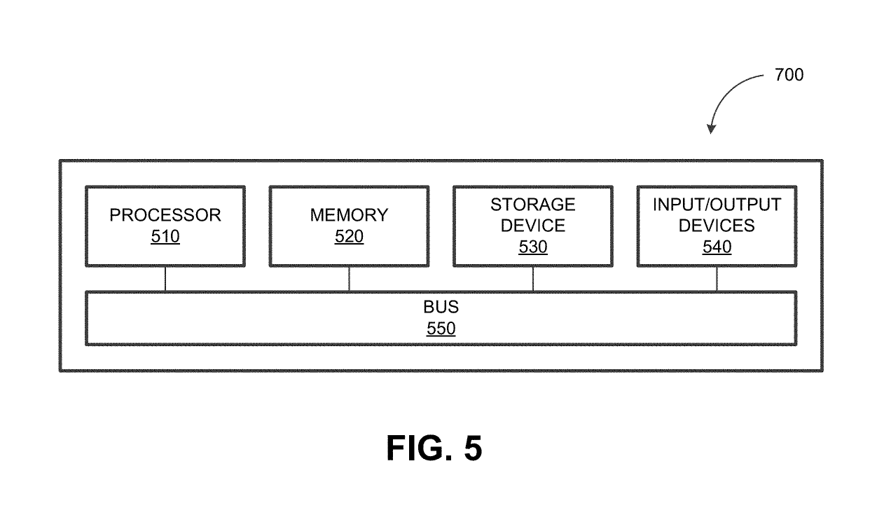

FIG. 5 depicts a block diagram illustrating a computing system 500 consistent with implementations of the current subject matter. Referring to FIGS. 1 and 5, the computing system 500 can be used to implement the graphical recommendation engine 110 and/or any components therein.

As shown in FIG. 5, the computing system 500 can include a processor 510, a memory 520, a storage device 530, and input/output devices 540. The processor 510, the memory 520, the storage device 530, and the input/output devices 540 can be interconnected via a system bus 550. The processor 510 is capable of processing instructions for execution within the computing system 500. Such executed instructions can implement one or more components of, for example, the graphical recommendation engine 110. In some example embodiments, the processor 510 can be a single-threaded processor. Alternately, the processor 510 can be a multi-threaded processor. The processor 510 is capable of processing instructions stored in the memory 520 and/or on the storage device 530 to display graphical information for a user interface provided via the input/output device 540.

The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some example embodiments, the input/output device 540 includes a keyboard and/or pointing device. In various implementations, the input/output device 540 includes a display unit for displaying graphical user interfaces.

According to some example embodiments, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some example embodiments, the computing system 500 can be used to execute various interactive computer software applications that can be used for organization, analysis and/or storage of data in various formats. Alternatively, the computing system 500 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities (e.g., SAP Integrated Business Planning as an add-in for a spreadsheet and/or other type of program) or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A system, comprising:
at least one data processor; and
at least one memory storing instructions which, when executed by the at least one data processor, result in operations comprising:
querying, by a graphical recommendation engine, a database to at least retrieve one or more resource profiles from the database;
generating, by the graphical recommendation engine, a graph representative of the one or more resource profiles retrieved from the database, the graph representative of the one or more resource profiles including at least one relationship between a first attribute and a second attribute included in the one or more resource profiles; and
generating, by the graphical recommendation engine, a recommendation for a target user, the recommendation generated based on at least a portion of the graph representative of the one or more resource profiles.

2. The system of claim 1, wherein the first attribute and the second attribute are included in a first resource profile.

3. The system of claim 2, wherein the recommendation comprises a third attribute included in a second resource profile that also includes the first attribute and the second attribute.

4. The system of claim 3, wherein the graphical recommendation engine identifies the third attribute in response to determining that the first resource profile is same and/or similar to the second resource profile, and wherein the graphical recommendation engine determines that the first resource profile is same and/or similar to the second resource profile by at least applying a collaborative filter to the graph representative of the one or more resource profiles.

5. The system of claim 2, wherein the recommendation comprises the second attribute, and wherein the graphical recommendation engine identifies the second attribute by at least traversing the graph representative of the one or more resource profiles.

6. The system of claim 5, wherein the graph includes a first node associated with the first attribute and a second node associated with the second attribute.

7. The system of claim 6, wherein the graphical recommendation engine traverses the graph representative of the one or more resource profiles by at least performing a breadth first search and/or a depth first search, and wherein the breadth first search and/or the depth first search starts at the first node associated with the first attribute and follows a directionality of an edge connecting the first node to the second node.

8. The system of claim 7, wherein the edge connecting the first node and the second node is associated with a weight, wherein the generation of the graph includes determining the weight based at least on a quantity of users who have transitioned from the first attribute associated with the first node to the second attribute associated with the second node, and wherein the recommendation includes identifying, based at least on the weight, the first attribute as being associated with a highest quantity and/or a lowest quantity of users who have transitioned to another attribute.

9. The system of claim 6, wherein the recommendation comprises a shortest path from the first node to the second node, wherein the shortest path minimizes a quantity of nodes and/or time required to transition from the first attribute associated with the first node to the second attribute associated with the second node, and wherein the graphical recommendation engine determines the shortest path by at least applying, to the graph representative of the one or more resource profiles, Dijkstra's algorithm.

10. The system of claim 1, further comprising:
storing, by the graphical recommendation engine, the graph representative of the one or more resource profiles at the database; and
generating the recommendation for the target user by at least querying the database to retrieve at least the portion of the graph representative of the one or more resource profiles.

11. A method, comprising:
querying, by a graphical recommendation engine, a database to at least retrieve one or more resource profiles from the database;
generating, by the graphical recommendation engine, a graph representative of the one or more resource profiles retrieved from the database, the graph representative of the one or more resource profiles including at least one relationship between a first attribute and a second attribute included in the one or more resource profiles; and
generating, by the graphical recommendation engine, a recommendation for a target user, the recommendation generated based on at least a portion of the graph representative of the one or more resource profiles.

12. The method of claim 11, wherein the first attribute and the second attribute are included in a first resource profile.

13. The method of claim 12, wherein the recommendation comprises a third attribute included in a second resource profile that also includes the first attribute and the second attribute.

14. The method of claim 13, wherein the graphical recommendation engine identifies the third attribute in response to determining that the first resource profile is same and/or similar to the second resource profile, and wherein the graphical recommendation engine determines that the first resource profile is same and/or similar to the second resource profile by at least applying a collaborative filter to the graph representative of the one or more resource profiles.

15. The method of claim 12, wherein the recommendation comprises the second attribute, and wherein the graphical recommendation engine identifies the second attribute by at least traversing the graph representative of the one or more resource profiles.

16. The method of claim 15, wherein the graph includes a first node associated with the first attribute and a second node associated with the second attribute.

17. The method of claim 16, wherein the graphical recommendation engine traverses the graph representative of the one or more resource profiles by at least performing a breadth first search and/or a depth first search, and wherein the breadth first search and/or the depth first search starts at the first node associated with the first attribute and follows a directionality of an edge connecting the first node to the second node.

18. The method of claim 17, wherein the edge connecting the first node and the second node is associated with a weight, wherein the generation of the graph includes determining the weight based at least on a quantity of users who have transitioned from the first attribute associated with the first node to the second attribute associated with the second node, and wherein the recommendation includes identifying, based at least on the weight, the first attribute as being associated with a highest quantity and/or a lowest quantity of users who have transitioned to another attribute.

19. The method of claim 16, wherein the recommendation comprises a shortest path from the first node to the second node, wherein the shortest path minimizes a quantity of nodes and/or time required to transition from the first attribute associated with the first node to the second attribute associated with the second node, and wherein the graphical recommendation engine determines the shortest path by at least applying, to the graph representative of the one or more resource profiles, Dijkstra's algorithm.

20. A non-transitory computer-readable medium storing instructions, which when executed by at least one data processor, result in operations comprising:
querying, by a graphical recommendation engine, a database to at least retrieve one or more resource profiles from the database;
generating, by the graphical recommendation engine, a graph representative of the one or more resource profiles retrieved from the database, the graph representative of the one or more resource profiles including at least one relationship between a first attribute and a second attribute included in the one or more resource profiles; and
generating, by the graphical recommendation engine, a recommendation for a target user, the recommendation generated based on at least a portion of the graph representative of the one or more resource profiles.
